(19) United States
(12) Patent Application Publication
(10) Pub. No.: US 2024/0284083 A1
(43) Pub. Date: Aug. 22, 2024

(54) HEADPHONES

(71) Applicant: Burmester Audiosysteme GmbH, Berlin (DE)

(72) Inventors: Stefan Größler, Berlin (DE); Ajan Hannemann, Berlin (DE); Pascal Bings, Berlin (DE)

(73) Assignee: Burmester Audiosysteme GmbH, Berlin (DE)

(21) Appl. No.: 18/571,430

(22) PCT Filed: Jun. 14, 2022
(86) PCT No.: PCT/EP2022/066129

§ 371 Date: Dec. 18, 2023

(30) Foreign Application Priority Data
Jun. 18, 2021 (EP) 21180298.8

(51) Int. Cl. H04R 1/10; H04R 5/033

(52) U.S. Cl. CPC H04R 1/1033; H04R 1/1008; H04R 5/033; H04R 2420/07; H04R 2420/09

(57) ABSTRACT

Headphones including a first and a second earcup (10, 20) and a band (2), wherein the band (2) is connected to the two earcups (10, 20) and carries the earcups (10, 20) when the headphones are used, wherein the first and the second earcup (10, 20) each have an electroacoustic sound generator, wherein the second earcup (20) is configured to be connected to a cable (40) and configured to receive an electrical signal associated with sound to be radiated by the electroacoustic sound generator of the first and second earcups, the cable causing an additional weight on the side in a weight difference between the first earcup (10) and the second earcup (20), the first earcup (10) having a balance weight (30) configures to reduce the weight difference between the first earcup (10) and the second earcup (20).

### TECHNICAL FIELD

Embodiments of the present disclosure relate to headphones. Headphones typically include at least one, preferably two earcups, each of which is equipped with an electroacoustic sound generator.

### BACKGROUND

In a typical design, headphone earcups comprise a housing which contains an electroacoustic sound generator. The sound generator contains a membrane, sometimes referred as diaphragm, which is deflected when electrical signals are applied to it, so that a sound is generated by the membrane. The earcup can have an ear pad ring which surrounds or lies over the ear of a user during normal use of the headphones.

There are multiple ways of connecting the headphones to an audio source. The headphones can be connected via one or more cables/wires or wireless, for example, using Bluetooth communication.

Headphones which are connected to an audio source with a cable, typically comprise only one earcup which is directly connected to the cable. The other earcup has no separate connection to the audio source but is connected to the cable via the first ear cup. This configuration may lead to an asymmetric feeling for a user wearing the headphones.

Headphones may also comprise a wireless connection module and a battery. However, the battery and the wireless connection module causes additional weight which is not necessary of the user uses the headphones with a cable.

Headphones are more comfortable if the weight can be reduced and if the experienced weight on both sides of the headphones during the use is essentially identical.

### SUMMARY

In light of the above, headphones according to the appended claims are suggested. Further aspects, advantages, and features are apparent from the dependent claims, the description, and the accompanying drawings.

Headphones are suggested according to the present disclosure with a first and a second earcup and a band, wherein the band is connected to the two earcups and carries the earcups when the headphones are used, wherein the first and the second earcup each comprise an electroacoustic sound generator configured to radiate sound. The first and the second earcups each can comprise and an ear pad ring, wherein the earpad ring surrounds or lies over an ear of a user when the headphones are used.

The second earcup is configured to be connected to a cable and configured to receive an electrical signal associated with sound to be radiated by the membranes of the first and second earcups. The cable causing an additional weight on the side of the second earcup on a user's head when the headphones are used resulting in a weight difference between the first earcup and the second earcup. The first earcup comprises a balance weight configured to reduce the weight difference between the first earcup and the second earcup.

According to a further aspect, headphones are suggested comprising a first earcup, a second earcup and a band, wherein the band is connected to the two earcups, an electroacoustic sound generator at each of the first and second earcups. The headphones further comprise a first connection element configured to be releasably connected to a battery module and a second connection element configured to be releasably connected to a wireless audio module and to receive an audio signal from the wireless audio module, wherein the headphones comprise a power path from the first connection element to the second connection element to provide a power supply from the battery module to the wireless audio module.

In some examples, battery module and wireless audio module can have essentially the same mass and first connection element is arranged at the first earcup and the second connection element is arranged at the second earcup.

The design of the headphones of the present disclosure is improved compared to conventional headphones. The comfort can be improved. In particular, headphones as described herein having the balance weight may significantly reduce or illuminate the asymmetric weigh distribution of the headphones due to a connected cable.

Headphones having first and second connection element can be used in a passive configuration with a cable and optionally a balance weight or in an active configuration with a battery and a wireless audio module to wirelessly receive an external audio signal. According to an aspect, the comfort of a user is increased in that the weight of the headphones is significantly reduced when used with a cable.

### BRIEF DESCRIPTION OF THE DRAWINGS

The accompanying drawing relates to embodiments of the disclosure and are described in the following:

FIG. 1 shows a schematic view of headphones having a balance weight;

FIG. 2 shows a schematic view of headphones having a battery module and wireless audio module attached to it.

### DETAILED DESCRIPTION OF EMBODIMENTS

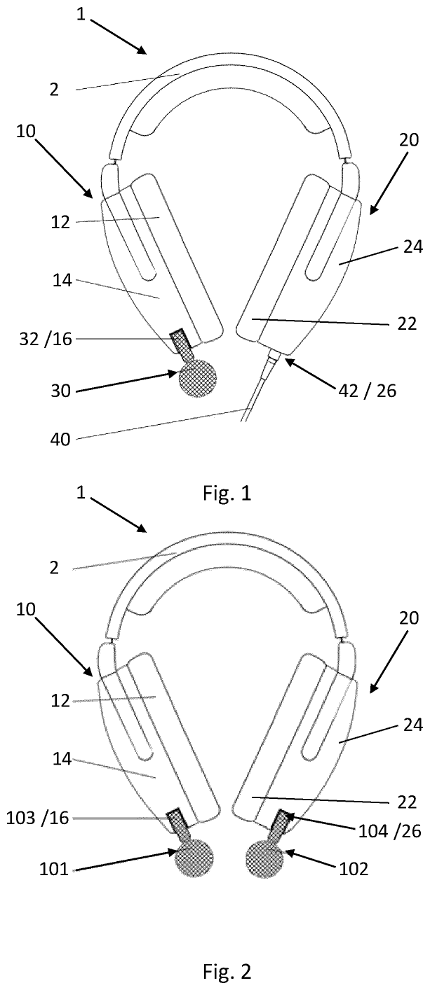

Reference will now be made in detail to the given example in FIG. 1 which is provided by way of explanation and is not meant as a limitation.

FIG. 1 illustrates exemplary headphones 1 according to an embodiment with a first and a second earcup 10, 20 and a band 2, wherein the band 2 is connected to the two earcups 10, 20 and carries the earcups 10, 20 when the headphones are used, wherein the first and the second earcup 10, 20 each comprise a housing 14, 24 and an electroacoustic sound generator configured to radiate sound. Headphones may comprise ear pad rings 12, 22, wherein the earpad rings 12, 22 surround or lie on ears of a user when the headphones are used. Headphones having such earpad rings 12, 22 are known as on-ear headphones or over-ear headphones.

Second earcup 20 is configured to be connected to a cable 40 and configured to receive an electrical signal associated with sound to be radiated by the first and second earcups 10, 20. Cable 40 causing an additional weight on the side of the second earcup 20 on a user's head when the headphones are used resulting in a weight difference between the first earcup 10 and the second earcup 20. First earcup 10 has a balance weight 30 configured to reduce the weight difference between the first earcup 10 and the second earcup 20. This reduces an asymmetric feeling for a user wearing the headphones and improves the user experience.

Each earcup 10, 20 comprises an electroacoustic sound generator configured to radiate sound. The electroacoustic sound generators are housed by housings 14, 24 as shown in FIG. 1. The second earcup 20 is configured to be connected to a cable 40 and configured to receive an electrical signal associated with sound to be radiated by the membranes of the first and second earcups 10, 20. The electrical audio signal may be transmitted from the second to the first earcup via a wire integrated in band 2. The headphones may be configured to receive two audio signals—one for each earcup 10, 20—through a single cable 40 as a stereo audio signal.

In the prior art, the earcups of headphones has been designed to have an essentially equal mass. In some cases, the earcup which is connected to the cable is even heavier than the other one because it additionally contains the phone jack/audio jack or audio socket. The additional weight of the free hanging portion of the cable influences the weight distribution negatively.

With the present disclosure, the balance weight 30 reduces or even eliminates the weight difference between the first earcup 10 and the second earcup 20 and increases the comfort for a user by balancing the weight distribution. A balance weight is a well-known technical term for a weight used in machines or devices to counterbalance a part. The balance weight is an additional feature compared to the prior art with the main function of providing mass to influence the weight distribution. Features or devices which are identical in both earcups 10, 20 are not considered as balance weights.

The average height of an ear of a sitting person is about 36-38″ or 91 cm to 96 cm from the floor. A balance weight may also be sized for a user sitting on a desk, wherein the cable lies on the desk. Balance weight 30 can have a mass which is essentially equal to a mass of a free hanging portion of the cable 40. This free hanging portion can have a length between 30 cm and 1.20 cm. Headphones may be included in a set with at least two balance weight, wherein a first balance has a mass which is essentially equal to a mass of a free hanging portion of the cable 40 when a user sits in front of a desk and the cable lies on the desk. A second balance weight has a mass which is essentially equal to a mass of a free hanging portion of the cable lying on the floor.

A mass of the balance weight 30 may be, for example, a mass between 5 g and 30 g, in particular, between 5 g and 20 g, and between 5 g and 15 g.

Balance weight 30 as shown in FIG. 1 is illustrated schematically. Usually, a balance weight is much smaller and may even be the size of a common plug connector. In the embodiment of FIG. 1, the balance weight 30 extends outside from the housing 14 of the first earcup 10. Alternatively, balance weight can be visually integrated in the bottom of the first earcup 10. For example, the shape of the balance weight 30 may follow the outer shape of the lower part of the earcup 10.

Balance weight 30 can be releasably attached to the first earcup 10. In other words, balance weight 30 can be detachable from the first earcup 10. Headphones can comprise a first connection element 16 configured to be connected to balance weight 30.

In some embodiments, headphones comprise first connection element 16 at the first earcup and second connection element 26 at the second ear cup. Both connection elements 16, 26 are configured to be connected to balance weight 30 and to cable 40. In particular, balance weight 30 may have a plug connector 32 and cable may have a plug connector 42, both configured to contact first and second connection elements 16, 26. Plug connector 32 of balance weight 30 is preferably electrical insulated to avoid interaction with the electroacoustic sound generators of the earcups 10, 20.

In some embodiments, balance weight 30 is releasably attached to the first earcup 10 and cable 40 is releasably attached to the second earcup 20, wherein balance weight 30 is also attachable to the second earcup 20 and cable 40 is also attachable to the first earcup 10. In other words, cable 40 and balance weight 30 are interchangeable. First and second earcups 10, 20 can have identically shaped jack connectors 16, 26.

In some examples, jack connector 16, 26 of the earcup(s) and plug connector 32/42 of balance weight 30 and/or cable 40 are headphone jack and jack plug.

According to a further aspect, headphones 1 are not actively powered. In other words, headphones 1 do not comprise an internal battery. However, headphones 1 may have a passive configuration and an active configuration as further explained with the example shown in FIG. 2.

FIG. 2 shows headphones comprising a first earcup 10) a second earcup 20 and a band 2, wherein the band 2 is connected to the two earcups 10, 20, an electroacoustic sound generator at each of the first and second earcups 10, 20. The headphones 1 further comprise a first connection element 16 configured to be releasably connected to a battery module 101 and a second connection element 26 configured to be releasably connected to a wireless audio module 102 and to receive an audio signal from the wireless audio module 102, wherein the headphones comprise a power path from the first connection element 16 to the second connection element 26 to provide a power supply from the battery module 101 to the wireless audio module 102.

Wireless audio module 102 can be configured to receive the audio signal via, for example, Bluetooth. Preferably, one of the connection elements 16, 26 is arranged at one earcup 10, 20 and the other connection element 16, 26 is arranged at the other earcup 10, 20.

Wireless audio module 102 may comprise wireless audio module connector 104 and battery module may comprise battery module connector 103 as shown in FIG. 2.

The first connection element 16 can be further configured to be releasably connected to the wireless audio module 102 and the second connection element 26 is further configured to be releasably connected to a battery module 101. In other words, the wireless audio module 102 and the battery module can be interchangeable or wireless audio module connector 104 and battery module connector 103 have the same plug shape.

The wireless audio module 102 and the battery module 101 can have essentially the same mass and cause the same weight on the headphones. In particular, both earcups 10, 20 can have the same weight without the battery module 101 and the wireless audio module 102 and also with the battery module 101 and the wireless audio module 102.

According to a further aspect, headphones 1 do not comprise an internal battery and can be used as passive headphones with cable 40 and balance weight 30 in a passive configuration. Headphones further can have an active configuration, wherein headphones 1 are connected to wireless audio module 102 and battery module 101, and wherein battery module 101 powers wireless audio module 102 and wireless audio module 102 receives an external audio signal wirelessly.

In particular, jack connector 16 and connection element 16 of first earcup 10 may be identical and therefore be configured to be connected to plug connector 32 of balance weight 30 and battery module connector 103 of battery module 101. Furthermore, second connection element 26 and jack connector 26 may be identical and therefore be configured to be connected to plug connector 42 of cable 40 and wireless audio module connector 104 of wireless audio module 102.

Battery module 101 and wireless audio module 102 can have the same weight/mass in order to reduce or illuminate the asymmetric weigh distribution of the headphones as explained above with regard to the balance weight and the cable.

### REFERENCE NUMBERS

1 headphones
2 band
10 first earcup
12 ear pad ring
14 housing
16 first connection element/jack connector
20 second earcup
22 ear pad ring
24 housing
26 second connection element/jack connector
30 balance weight
32 plug connector
40 cable
42 plug connector
101 battery module
102 wireless audio module
103 battery module connector
104 wireless audio module connector

1. Headphones comprising a first and a second earcup (10, 20) and a band (2), wherein the band (2) is connected to the two earcups (10, 20) and carries the earcups (10, 20) when the headphones are used, wherein the first and the second earcup (10, 20) each comprise an electroacoustic sound generator,
wherein the second earcup (20) is configured to be connected to a cable (40) and configured to receive an electrical signal associated with sound to be radiated by the electroacoustic sound generator of the first and second earcups, the cable causing an additional weight on the side of the second earcup (20) on a user's head when the headphones are used resulting in a weight difference between the first earcup (10) and the second earcup (20), the first earcup (10) having a balance weight (30) configured to reduce the weight difference between the first earcup (10) and the second earcup (20).

2. The headphones according to claim 1, wherein the balance weight (30) has a mass which is essentially equal to a mass of a free hanging portion of the cable (40).

3. The headphones according to claim 1, wherein the balance weight (30) is releasably attached to the first earcup (10).

4. The headphones according to claim 1, wherein the balance weight (30) has a plug connector (32) configured to be connected to a jack connector (16), wherein the first earcup (10) comprises the jack connector (16).

5. The headphones according to claim 1, wherein the jack connector (16) and the plug connectors (32) are headphone jack and jack plug.

6. The headphones according to claim 1, wherein the second earcup (20) comprises a jack connector (26) configured to be connected to a plug connector (42) of the cable (40) and wherein the jack connectors (16, 26) of the first and second earcups (10, 20) are both configured to be connected to a plug connector (32) of the balance weight (30).

7. The headphones according to claim 1, wherein the first earcup (10) is configured to be connected to a cable (40) and configured to receive an electrical signal associated with sound to be radiated by the membranes of the first and second earcups (10, 20).

8. The headphones according to claim 1, wherein the first and second earcups (10, 20) have identically shaped plug connectors (16, 26).

9. The headphones according to claim 1, wherein the balance weight (30) has a mass between 5 g and 30 g.

10. Headphones comprising a first earcup (10), a second earcup (20) and a band (2), wherein the band (2) is connected to the two earcups (10, 20), an electroacoustic sound generator at each of the first and second earcups (10, 20),
the headphones further comprising a first connection element (16) configured to be releasably connected to a battery module (101) and a second connection element (26) configured to be releasably connected to a wireless audio module (102) and to receive an audio signal from the wireless audio module (102), wherein the headphones comprise a power path from the first connection element (16) to the second connection element (26) to provide a power supply from the battery module (101) to the wireless audio module (102).

11. The headphones according to claim 10, wherein the first connection element (16) is arranged at the first earcup (10) and the second connection element (26) is arranged at the second earcup (20).

12. The headphones according to claim 10, wherein the first connection element (16) is further configured to be releasably connected to the wireless audio module (102) and the second connection element (26) is further configured to be releasably connected to a battery module (101).

13. The headphones according to claim 10, wherein the second connection element (26) is further configured to be connected to a cable (40) and to receive an audio signal from the cable.

14. The headphones according to claim 10, wherein the wireless audio module (102) and the battery module (101) have essentially the same mass.

15. A system comprising the headphones according to claim 10, the battery module (101) and the wireless audio module (102).

16. The headphones according to claim 2, wherein the free hanging portion of the cable (40) has a length between 30 cm and 1.20 cm.
